(19) United States
(12) Patent Application Publication
(10) Pub. No.: US 2024/0277073 A1
(43) Pub. Date: Aug. 22, 2024

(54) AN AEROSOL PROVISION SYSTEM

(71) Applicant: NICOVENTURES TRADING LIMITED, London (GB)

(72) Inventors: Joseph Sutton, London (GB); Sally Bell, London (GB)

(21) Appl. No.: 18/570,974

(22) PCT Filed: Jun. 24, 2022
(86) PCT No.: PCT/GB2022/051626

§ 371 Date: Dec. 15, 2023

(30) Foreign Application Priority Data
Jun. 25, 2021 (GB) 2109222.6

(51) Int. Cl. A24F 40/53; A24F 40/10; A24F 40/42; A24F 40/51; A24F 40/60

(52) U.S. Cl. CPC A24F 40/53; A24F 40/42; A24F 40/60; A24F 40/10; A24F 40/51

(57) ABSTRACT

A method of tracking an inventory of aerosolisable material for a non-combustible aerosol provision system involves receiving an input indicative of a change in a user's inventory of aerosolisable material and updating a stored indication of the inventory of aerosolisable material based on the input indicative of the change.

### FIELD AND BACKGROUND

The present disclosure relates to the field of aerosol provision systems. In particular, but not exclusively, the present disclosure relates to managing a supply of aerosolisable material for a non-combustible aerosol provision system.

A “non-combustible” aerosol provision system is an aerosol provision system where a constituent aerosol-generating material of the aerosol provision system (or component thereof) is not combusted or burned in order to facilitate delivery of at least one substance to a user.

The non-combustible aerosol provision system may be an electronic cigarette, also known as a vaping device or electronic nicotine delivery system (END), although it is noted that the presence of nicotine in the aerosol-generating material is not a requirement.

The non-combustible aerosol provision system may be an aerosol-generating material heating system, also known as a heat-not-burn system. An example of such a system is a tobacco heating system.

The non-combustible aerosol provision system may be a hybrid system to generate aerosol using a combination of aerosol-generating materials, one or a plurality of which may be heated. Each of the aerosol-generating materials may be, for example, in the form of a solid, liquid or gel and may or may not contain nicotine. The hybrid system may comprise a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

The non-combustible aerosol provision system, such as a non-combustible aerosol provision device thereof, may comprise a power source and a controller. The power source may, for example, be an electric power source or an exothermic power source. The exothermic power source comprises a carbon substrate which may be energised so as to distribute power in the form of heat to an aerosol-generating material or to a heat transfer material in proximity to the exothermic power source.

The non-combustible aerosol provision system may comprise an area for receiving the consumable, an aerosol generator, an aerosol generation area, a housing, a mouthpiece, a filter and/or an aerosol-modifying agent.

The consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Known approaches are described in WO2014199233A2, WO2015128665A1, US2017027229A1, WO2015138589A1, WO2019060305A1, US20140246035A1, WO2014058678A1, WO2012027350A2, EP3210481A1, WO2020229045A1, U.S. Pat. No. 9,877,505B2, and U.S. Pat. No. 9,888,725B2.

### SUMMARY

Viewed from a first aspect, there is provided a method of tracking an inventory of aerosolisable material for a non-combustible aerosol provision system, the method comprising: receiving an input indicative of a change in a user's inventory of aerosolisable material; and updating a stored indication of the inventory of aerosolisable material based on the input indicative of the change.

Viewed from a second aspect, there is provided a user device comprising a processor configured to: receive an input indicative of a change in a user's inventory of aerosolisable material; and update a stored indication of the inventory of aerosolisable material based on the input indicative of the change.

Viewed from a third aspect, there is provided a computer-readable medium comprising instructions which, when executed by processing circuitry of a computing device, cause the computing device to: receive an input indicative of a change in a user's inventory of aerosolisable material; and update a stored indication of the inventory of aerosolisable material based on the input indicative of the change.

### BRIEF DESCRIPTION OF FIGURES

Embodiments and examples of the present approaches will now be described, by way of example only, with reference to the accompanying drawings, in which:

FIG. 1 is a schematic illustrating an example of a non-combustible aerosol provision system;

FIG. 2 is a schematic illustrating an example of a user device;

FIG. 3 is a flowchart illustrating a method of tracking an inventory of aerosolisable material for a non-combustible aerosol provision system;

FIG. 4 is a flowchart illustrating a method of responding to an inventory of aerosolisable material falling below a threshold;

FIG. 5 is a flowchart illustrating a method of tracking an inventory of aerosolisable material in which a storage element on a pod is updated;

FIG. 6 is a flowchart illustrating a method of managing a supply of aerosolisable material for a non-combustible aerosol provision system;

FIG. 7 is a method of tracking usage of aerosolisable material for a non-combustible aerosol provision system;

FIGS. 8A-8E illustrate example inventories of aerosolisable material; and

FIGS. 9A-9C are schematics illustrating user interfaces used in managing a supply of aerosolisable material for a non-combustible aerosol provision system.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

A non-combustible aerosol provision system is used with a consumable aerosol-generating material, referred to herein as aerosolisable material. This may be provided to the non-combustible aerosol provision system in a number of ways, however typically the non-combustible aerosol provision system can be used with pods containing the aerosolisable material, which pods may themselves be single use or refillable.

However the aerosolisable material is provided to the non-combustible aerosol provision system, the aerosolisable material is consumed through use of the system. Because the aerosolisable material is consumed in this way, a user's supply of aerosolisable material can be depleted over time and if this supply runs out, the user may be unable to use the non-combustible aerosol provision system until the supply has been replenished.

To reduce the chance of running out of aerosolisable material, the techniques described herein allow the user to manage their supply of aerosolisable material by variously tracking an inventory of aerosolisable material, determining whether the user's supply of aerosolisable material is sufficient for their use, and/or recording and monitoring how the user uses the non-combustible aerosol provision system.

In this way, the user is provided with a greater level of control over their supply of aerosolisable material in such a way that a likelihood of the supply running out can be reduced. The techniques described herein also provide convenient mechanisms for the user to order more aerosolisable material or otherwise take pre-emptive steps to avoid ensure that they will not run out of aerosolisable material.

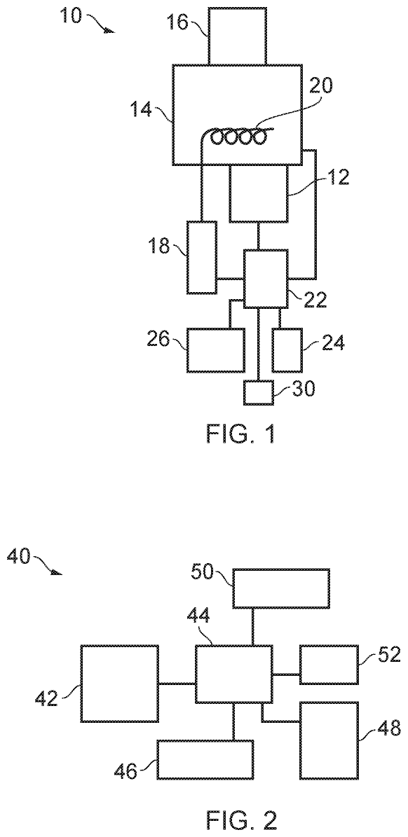

It will be appreciated that the present approaches involve transmission of data to and from a non-combustible aerosol provision system, and for the non-combustible aerosol provision system to process stored and/or received data. Also, the present approaches require a user device to be capable of communicating with a non-combustible aerosol provision system. Such a user device may be capable of communicating with other services or systems. Therefore, to illustrate suitable devices for providing such functionalities, an example non-combustible aerosol provision system 10 and an example user device 40 are illustrated with respect to FIGS. 1 and 2 respectively.

An example of a non-combustible aerosol provision system 10 is schematically illustrated in FIG. 1. As shown, the aerosol delivery device 10 is a device which contains elements relating to aerosol generation such as an aerosol medium container or cartridge 12 (in the case of an END device, the aerosol medium container or cartridge 12 will contain nicotine or a nicotine-bearing formulation), an aerosol generation chamber 14 and an outlet 16 through which a generated aerosol may be discharged. A battery 18 may be provided to power a thermal generator element (such as a heater 20) within (or functionally adjacent to) the aerosol generation chamber 14. The battery 18 may also power a processor/controller 22 which may serve purposes of device usage, such as activation of the device for aerosol generation in response to an activation trigger, and purposes of communication and functionality control. Processor/controller 22 may have access to a memory 24 which may be used to store operating instructions for the processor/controller 22. The memory 24 may also be used to store data describing operating conditions and/or states of the non-combustible aerosol provision system 10 and/or one or more components thereof. The memory 24 may be internal to the processor/controller 22 or may be provided as an additional separate physical element.

To perform transmission and reception of data and/or messaging, the processor/controller 22 is provided with a transmitter/receiver element 26. The transmitter/receiver element 26 enables the non-combustible aerosol provision system 10 to communicate with a connected device using a connectivity technology such as a personal area network protocol. Example personal area network protocols include Bluetooth™, Bluetooth Low Energy™ (BLE), Zigbee™, Wireless USB, and Near-Field Communication (NFC). Example personal area network protocols also include protocols making use of optical communication such as Infrared Data association (IrDA), and data-over-sound. Other wireless technologies such as a Wi-Fi™ technology may be used if the non-combustible aerosol provision system has suitable capability. In other examples, the transmitter/receiver element 26 may be configured to provide for a wired communication channel provided between physical ports of the non-combustible aerosol provision system 10 and a connected device. Such a wired communication channel may utilise a physical connection technology such as USB™, a serial port, FireWire™ or other point-to-point wired connectivity. The remainder of this discussion will use the example of BLE and will use BLE terminology, although it will be appreciated that corresponding or equivalent functionalities of other personal area network technologies may be substituted. Thus, in the present example, the transmitter/receiver element 26 is a BLE interface element including or connected to a radio antenna for wireless communication. In other examples such as those indicated above this may be an interface element for an alternative wireless technology and/or a wired connection interface.

Any communication established with a connected device may be impermanent or otherwise transient in the sense that the channel may be established for a period of time necessary to carry out specific functionalities, but may also be disconnected when not required. For this reason such a connected device will be referred to herein as a user device, in the sense that the device is likely to be utilised and/or controlled by a user of the non-combustible aerosol provision system 10 and a connected device. An example of such a user device (which may also be termed a remote device, in the sense that the device is remote from the non-combustible aerosol provision system, or intermediary device, in the sense that the device is intermediate between the non-combustible aerosol provision system and the unlock/age verification services) is described below with reference to FIG. 2.

Returning to the discussion of FIG. 1, the processor/controller 22 may in one example be an STM32 microcontroller as provided by ST Microelectronics and based on the ARM™ Cortex™-M processor. In other examples an alternative microcontroller or processor may be used, which may be based upon an ARM™ architecture, and Atom™ architecture or other low power processor technology. Alternatively or additionally, the transmitter/receiver element 26 may in one example include an nRF BLE chip for cooperating with the processor/controller to provide BLE connectivity to the non-combustible aerosol provision system. In other examples, other communication interface chips or modules may be deployed to provide connectivity services.

As illustrated, processor/controller 22 may be connected for example to aerosol medium container or cartridge 12, aerosol generation chamber 14 and battery 18. This connection may be to an interface connection or output from ones of the components and/or may be to a sensor located at or in ones of the components. These connections may provide access by the processor to properties of the respective components. For example a battery connection may be used to control activation of the non-combustible aerosol provision system for aerosol generation.

Further functionalities of the processor/controller 22 and/or the memory 24 will be described with reference to the examples of the present approaches below.

An example of a user device 40 is schematically illustrated in FIG. 2. The user device may be a device such as a mobile telephone (cellphone) or tablet of a user (and/or owner) of the non-combustible aerosol provision system 10. As shown, the user device 40 includes a receiver transmitter element 42 for communicating with a non-combustible aerosol provision system 10. Thus the receiver transmitter element 42 will be configured to use the same connectivity and protocols etc as the non-combustible aerosol provision system 10 with which it is to interact in any given implementation. Accordingly, in the present examples, the receiver transmitter element 42 is a BLE interface element including or connected to a radio antenna for wireless communication. In other examples such as those indicated above this may be an interface element for an alternative wireless technology and/or a wired connection interface.

The receiver transmitter element 42 is connected to a processor or controller 44 which can receive and process the data or messaging received from the non-combustible aerosol provision system. The processor or controller 44 has access to a memory 46 which can be used to store program information and/or data. The user device 40 may include a further data transmission interface 48. This interface may provide one or more interface functionalities, for example to a wired connection such as wired local area network and/or to a wireless connection such as wireless local area network and/or cellular data services. This interface may be used for example for sending and receipt of messaging to and from various other devices, computer systems, and/or computer services as required by any particular implementation. This interface may also or alternatively be used for communications relating to other functionalities of the user device 40 which are unrelated to operation of or interaction with a non-combustible aerosol provision system.

The user device 40 also includes user interface elements including an output device 50 (which may include one or more of a display, an audio output, and a haptic output) and an input device 52 (which may include one or more of buttons, keys, touch-sensitive display elements, or a mouse/trackpad).

The user device 40 may be pre-programmed or configured to provide the functionalities according to the approaches discussed below. Additionally or alternatively, the user device may store software (e.g. in memory 46) such as an app to cause the processor or controller 44 to have those functionalities when the software is executed. Thus the user device may be a multi-purpose device that has the described functionalities when the app is executed.

Software to cause the user device to become programmed for the techniques described herein may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media such as carrier signals and transmission media. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. The term “computer-readable storage media” refers to physical storage media. Transient communication media may occur between components of a single computing system (e.g. on an internal link or bus between e.g. a memory and processor) or between separate computing systems (e.g. over a network or other inter-computing device connection), and may include transmission signals, carrier waves or the like.

Such software may be loaded directly to the user device 40 from a computer-readable medium, or may be loaded to the user device by connecting the user device to another computing device (such as a desktop computer, laptop computer or the like) and using software on the other computing device to control the loading of software to the user device.

Thus there have been described a non-combustible aerosol provision system and a user device that may interact to provide a number of additional functionalities for the non-combustible aerosol provision system to a user of the user device. Examples of such functionalities will now be described.

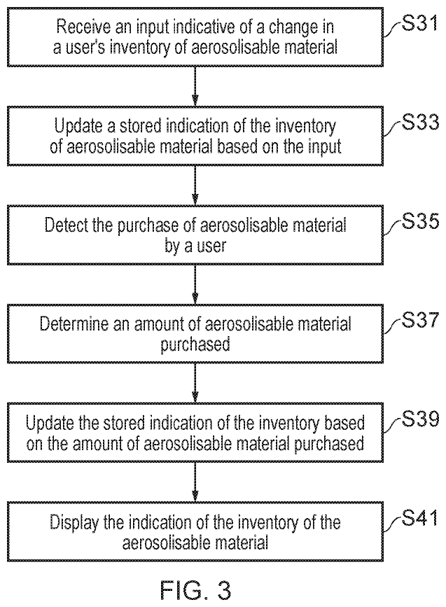

FIG. 3 is a flowchart illustrating a method of tracking an inventory of aerosolisable material for a non-combustible aerosol provision system.

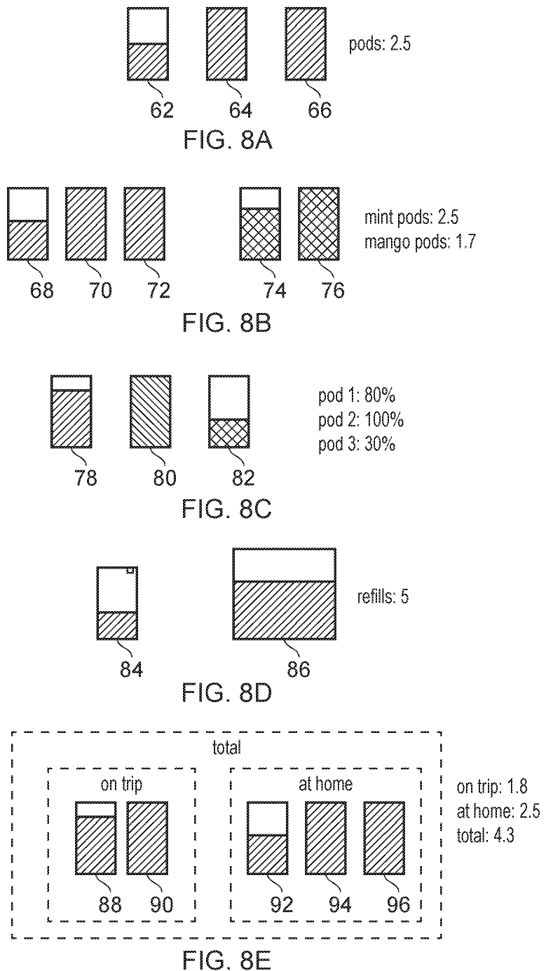

The user's inventory of aerosolisable material refers to an amount of aerosolisable material available to the user. In some cases, this is the total amount of aerosolisable material owned by the user, which may be split across several pods of aerosolisable material. In this case, the inventory may identify the level of aerosolisable material in each pod or may identify a total amount of aerosolisable material spread across a range of pods without an indication of which pods the material is in. In some examples, the non-combustible aerosol provision system 10 operates with refillable pods and the inventory represents an amount of refill liquid. In yet further examples, the non-combustible aerosol provision system 10 comprises a reservoir to store aerosolisable material and so the non-combustible aerosol provision system 10 may operate without the use of pods at all. In such examples, the inventory may represent a total amount of fluid (the aerosolisable material) that the user has in the reservoir and stored separately for refilling the reservoir. The inventory of aerosolisable material will be discussed in more detail below with reference to FIGS. 8A-8E.

As shown in FIG. 3, at step S31 an input indicative of a change in a user's inventory of aerosolisable material is received. This input may take a number of forms and may depend on the cause of the change in the user's inventory.

In some examples, the input is a user input entered for example on a user device 40 that specifies the change in the user's inventory. For example, the user may enter on the user device 40 a number of pods of aerosolisable material that they have purchased. This would therefore correspond to an increase in the user's inventory of aerosolisable material. The user input may also indicate a decrease in the inventory of aerosolisable material. For example, the user may specify that a currently indicated inventory of aerosolisable material is too high and should be revised downwards, e.g., where the user has given away/lost a pod or used a pod with another device. By supporting a user input in this way, the user device 40 is able to maintain an accurate inventory reflective of the user's actual inventory that might not be possible if only automated means for detecting changes in the inventory were used. That is to say, although automated techniques for detecting changes in the user's supply of aerosolisable material can provide in many cases provide seamless tracking of the inventory, there are some events that may lead to a change in the inventory that may not always be adequately detected using such automated techniques. Hence, by supporting user input to indicate a change in the inventory, an accurate indication of the amount of aerosolisable material available to the user can be maintained.

Additionally or alternatively, the input indicative of the change in a user's inventory received at step S31 may be received from the non-combustible aerosol provision system 10 itself. Since the non-combustible aerosol provision system 10 causes consumption of the aerosolisable material, the non-combustible aerosol provision system 10 may be able to track that consumption and indicate the change to the user device. For example, the non-combustible aerosol provision system 10 may determine based on use by the user, an amount of aerosolisable material consumed and communicate this to the user device 40 as the input indicative of a change. In some examples, the non-combustible aerosol provision system 10 calculates the change in the inventory of aerosolisable material itself by determining a change in the level of aerosolisable material in a pod by calculating an amount of aerosolisable material consumed based on a length/number of puffs on the non-combustible aerosol provision system. Such a determined change in the level of aerosolisable material in the pod may be applied to a known, detected or estimated previous level of aerosolisable material in the pod to calculate a remaining level.

Similarly, the non-combustible aerosol provision system 10 may provide details relating to the use of the non-combustible aerosol provision system 10 to the user device 40 from which the user device 40 itself can determine the change in the inventory. For example, the non-combustible aerosol provision system 10 may determine a length of one or more puffs on the user device, a number of puffs, and/or a heater power level when the puffs were performed. Based on these data, the user device 40 may be able to calculate the change in the user's inventory. Again a determined change in level of remaining aerosolisable material may be applied to a known, detected or estimated previous level to calculate a remaining level.

By making use of input from the non-combustible aerosol provision system 10 in this way, the user device 10 may be able to automatically track changes in the supply of aerosolisable material as the user uses the device without manual intervention from the user to specify how much material has been used.

In some examples, the non-combustible aerosol provision system 10 is operable in an “auto-draw” mode of operation with the auto-draw functionality being additionally used to inform the input indicative of the change in the user's inventory at step S31. In this auto-draw mode, the non-combustible aerosol provision system 10 is configured to detect a puff or puffs on the device and based on the puff(s), control the non-combustible aerosol provision system 10 to generate aerosols for consumption by the user. The puff(s) may be detected using a pressure sensor of the non-combustible aerosol provision system 10 by comparing a pressure within a mouthpiece of the non-combustible aerosol provision system 10 with an ambient pressure. As the user puffs on the non-combustible aerosol provision system 10, the pressure within the mouthpiece will be reduced which can be detected as a pressure difference between the ambient pressure and the pressure in the mouthpiece. The puff or puffs could be similarly be detected by a flow sensor detecting a flow of air through the non-combustible aerosol provision system 10 caused by the user puffing.

A non-combustible aerosol provision system 10 in the auto-draw mode is responsive to detection of the puff(s) to control the non-combustible aerosol provision system 10 to generate aerosols. The control may involve starting the generation of aerosols when a puff is detected thereby providing a way for the user to signal to the non-combustible aerosol provision system 10 when the user wishes to use the device. In some examples however, the non-combustible aerosol provision system 10 additionally controls parameters relating to how the aerosolisable material is aerosolised based on characteristics of the puff. For example, a deeper puff (which could be detected by a greater difference between the mouthpiece pressure and the ambient pressure) could cause the non-combustible aerosol provision system 10 to operate the heater 20 at a higher power level and/or continue producing aerosolisable material for a greater length of time. In this way, the user can control the operation of the non-combustible aerosol provision system 10 in an intuitive manner by altering how they puff on the non-combustible aerosol provision system 10.

The characteristics of the user's puff or puffs (e.g., the length of puff, flow rate during the puff, and/or the pressure difference) may be used as the input indicative of the change in the user's inventory. That is, the non-combustible aerosol provision system 10 could provide this information to the user device 40 based on which the user device 40 may be able to determine an amount of aerosolisable material consumed during that use of the non-combustible aerosol provision system 10. The non-combustible aerosol provision system 10 may alternatively or additionally provide details of the how the non-combustible aerosol provision system 10 was controlled in response to the puffs (e.g., the heater power level used or time for which the heater 20 was operated) with this information being used by the user device 40 to determine the amount of aerosolisable material consumed. In yet further examples, the non-combustible aerosol provision system 10 calculates the amount of aerosolisable material consumed during operation while responding to the user's puff(s), with this amount communicated to the user device as the input indicative of the change in the inventory of aerosolisable material at step S31.

Another possible form of input that may be received at step S31 is an indication that a pod for use with the non-combustible aerosol provision system 10 has been changed (e.g., removed or inserted). Based on this information, the user device 40 may infer that all the aerosolisable material in the pod has been consumed. Alternatively, in examples where the inventory separately indicates an amount of aerosolisable material of different types, the indication that a pod has been changed may serve to indicate that a different type of material is being consumed.

It will be appreciated that the user device 40 may be responsive to more than one of the different types of input described herein, thereby allowing the indication of the inventory to be modified in several different ways. This allows the user device 40 to better respond to changes in the inventory aerosolisable material occurring for different reasons and increase the accuracy of the stored indication of the inventory.

Having received the input indicative of the change in the user's inventory, the user device 40 updates a stored indication of the inventory of aerosolisable material based on the input. The indication of the inventory may be stored on the user device 40 itself, on a remote server to which the user device 40 has access, and/or on the non-combustible aerosol provision system 10 itself. Regardless of the form of the indication, the change in inventory received is reflected in the update to the stored indication. For example, where the input comprises user input specifying that a pod was lost/given away, the user device 40 is configured to revise the indication of the inventory down by one pod (or by the equivalent amount of aerosolisable material). On the other hand, where the input comes from the non-combustible aerosol provision system 10 and reflects aerosolisable material consumed in use of the non-combustible aerosol provision system 10, the change in aerosolisable material may be less than that of a whole pod and so the user device 10 is configured to alter the stored indication of the inventory to reflect a fraction of a pod being used.

By receiving input indicative of a change in the user inventory and updating the inventory of aerosolisable material in this way, the user device is able to maintain an up-to-date indication of the amount of aerosolisable material that a user has available.

The user device 40 may also be able to handle the situation where the user has more than one non-combustible aerosol provision system. In this case, the method may further comprise receiving from a second non-combustible aerosol provision system, second usage inflation indicative of an amount of aerosolisable material used and updating the stored indication of the inventory of aerosolisable material. This allows the inventory to be accurately tracked in the case where the user has more than one non-combustible aerosol provision system and so a change in the inventory could occur due to use any of the systems. In this case, the inventory may comprise a combined inventory for both/all of the non-combustible aerosol provision systems, e.g., where the aerosolisable material is interchangeable and can be used with both systems. However, the user device 40 may also be able to support an inventory with two or more different types of aerosolisable material in case the non-combustible aerosol provision systems are not compatible with the same types of aerosolisable material.

Returning to FIG. 3, another way in which the inventory of aerosolisable may be altered is by the user purchasing more aerosolisable material. As shown in step S35, the user device 40 may detect such a purchase of aerosolisable material. This can occur due to the purchase taking place in the same or related software on the device (e.g., the user ordering more pods through an app on the user device) or the software automatically detecting an automatic purchase of more aerosolisable material when the supply is low. In some examples, the purchase of aerosolisable material is detected based on a user's account being linked with the user device 40. A user's purchase of aerosolisable material may thus be linked to an account registered on the user device 40 even if the purchase was made on a separate device. In further examples, the purchase of aerosolisable material is detected based on a confirmation of purchase being received in an email application (or other messaging application) of the user.

In response to detecting a purchase of additional aerosolisable material, an amount of aerosolisable material purchased is determined at step S37 and the stored indication of the inventory is updated at step S39 based on the amount of aerosolisable material purchased. For example, the user may order a set of 10 replacement pods of aerosolisable material through an app on the user device 40 which detects the purchase. Based on identifying that 10 replacement pods were ordered, the user device 40 would then update the inventory to include the additional 10 pods. This provides a convenient way for the user to manage their inventory without needing to manually indicate the additional aerosolisable material.

The indication of the inventory can be used in a number of ways, however, in the example shown in FIG. 3, the calculated indication of the inventory of aerosolisable material is displayed to the user at step S41 using the output device 50 of the user device 40. Hence, the user is provided with an accurate indication of how much aerosolisable material they have available.

The indication of the inventory of aerosolisable material may be presented to the user as an amount corresponding to a percentage of a full pod. In such a case, an inventory of 50% would indicate that the user has half a pod of aerosolisable material remaining and an inventory of 200% would indicate that the user has two pods (or an equivalent amount corresponding to two pods' worth) of aerosolisable material remaining.

Additionally or alternatively, the inventory of aerosolisable material could be indicated by displaying an icon, symbol, or colour corresponding to the amount of inventory. For example, the levels of inventory could be categorised into different colours, e.g., with red to indicate that the inventory comprises less than two remaining pods, orange to indicate between two and fours pods, and green to indicate that the user has four or more pods' worth of aerosolisable material remaining. The appropriate colour, icon or symbol corresponding to the remaining amount of aerosolisable material may then be displayed to the user to indicate the inventory. The mapping between inventory levels and colours, icons, or symbols may be predetermined and set for example by the manufacturer or default, or may be set by the user based on the user's preferences and/or an inventory level that the user would like to maintain. In some examples, the mapping between colours, icons or symbols is set based on an observed rate of consumption of aerosolisable material such that each colour, icon or symbol represents an amount of aerosolisable material predicted to be consumed in a particular amount of time.

Thus there have been described approaches for tracking a quantity of aerosolisable material for a non-combustible aerosol provision system remaining in a user inventory.

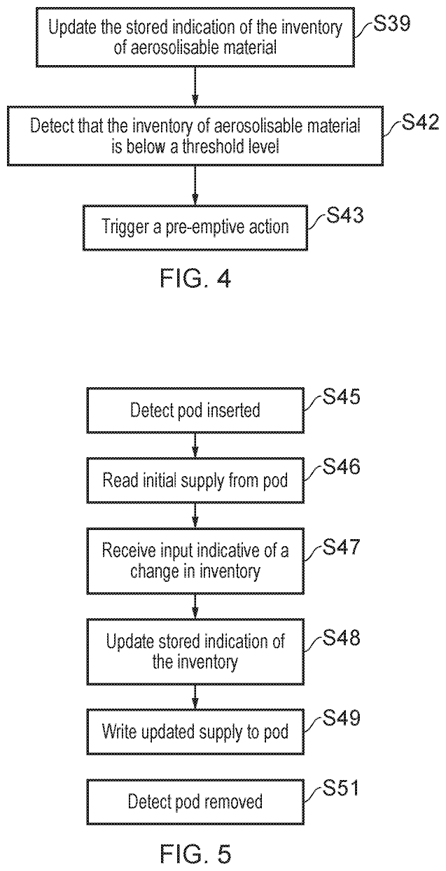

As well as, or instead of displaying the indication of the user's inventory, the method may involve checking whether the inventory is sufficient for the user's needs. As illustrated in FIG. 4, this occurs by comparison of the inventory to a threshold.

At step S39 of FIG. 4 (corresponding to step S39 of FIG. 3), the stored indication of the inventory of aerosolisable material is updated (this may correspond for example to either or both of step S33 and S39). This updated inventory is then compared against a threshold. The threshold may be pre-determined and set for example by the manufacturer as a default, or may be set by the user based on an inventory level that they would like to maintain. In some examples, the threshold is calculated based on an observed rate of consumption of aerosolisable material by the user such that the threshold level corresponds to usage for a pre-determined period of time. For example, the threshold level may be set to correspond to one day's usage of the non-combustible aerosol provision system 10.

When it is detected at step S42 that the inventory of aerosolisable material falls below the threshold level, the user device 40 is configured to take a pre-emptive action at step S43. By applying the threshold in this way and acting pre-emptively, rather than waiting until the user has run out of aerosolisable material before responding, this approach reduces the chance that the user will run out of aerosolisable material, thereby preventing him/her from using the non-combustible aerosol provision system 10. Instead, by anticipating the exhaustion of the supply, more aerosolisable material can be purchased or the rate at which aerosolisable material is used can be slowed to avoid running out of aerosolisable material.

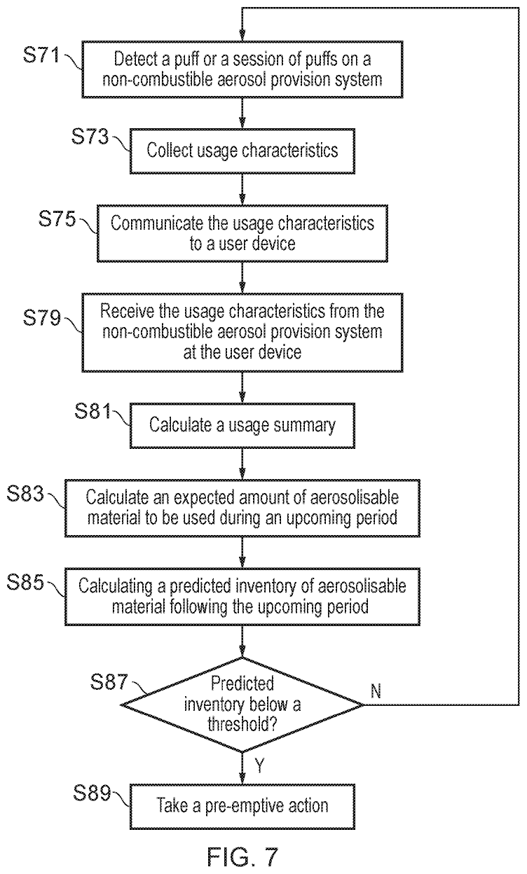

The pre-emptive action may take a number of forms which will be discussed in more detail in relation to step S61 of FIG. 7, however, in some examples the pre-emptive action comprises one of notifying the user, prompting the user to order more aerosolisable material, ordering more aerosolisable material on behalf of the user, and causing the non-combustible aerosol provision system to enter an aerosolisable material conserving mode.

The techniques described herein may be performed with non-combustible aerosol provision systems of a number of forms operable with a range of different mechanisms for providing the aerosolisable material. As discussed above, pods of aerosolisable material may be inserted into the non-combustible aerosol provision system to provide the system with aerosolisable material. In some cases, the non-combustible aerosol provision system is not able to distinguish between pods and so the inventory is maintained indicating a total level of aerosolisable material across a potential plurality of pods but without identifying a level of aerosolisable material in a particular pod.

However, in some examples, the non-combustible aerosol provision system 10 is operable with pods comprising a storage element to store data describing a supply level of aerosolisable material for that pod. The storage element may for example comprise flash memory able to store information that can be read, and may also be modifiable, by the non-combustible aerosol provision system 10 while the pod is inserted in the non-combustible aerosol provision system 10.

Thus there has been described an approach by which action may be automatically triggered and/or taken based upon detected changes to a user inventory of aerosolisable material for a non-combustible aerosol provision system, in particular when a certain degree of depletion of that inventory is detected.

FIG. 5 is a flowchart illustrating a method of tracking an inventory of aerosolisable material in which a storage element on a pod is updated. As shown in FIG. 5, at step S45, insertion of the pod into the non-combustible aerosol provision system 10 is detected. This may occur due to electrical contacts on the pod completing a circuit and being detected by the non-combustible aerosol provision system 10, an electrical resistance of the pod being detected, the pod depressing a contact switch as the pod is inserted, or an RFID/NFC communication possibility with the pod being detected, for example. In response to detecting insertion of the pod, the non-combustible aerosol provision system 10 reads, from the storage element of the pod, an initial supply corresponding to an amount of aerosolisable material initially stored in the pod. The reading may be based upon physical electrical connection between the non-combustible aerosol provision system and the pod, and/or based upon a wireless (e.g. RFID or NFC) connection between the non-combustible aerosol provision system and the pod. For a new pod, the initial supply may have been set when the pod was first filled and indicate that the pod is full and may also indicate a capacity and/or contents of the pod (e.g., type/flavour of aerosolisable material). For a pod that has already been used, the initial supply may have been written to the pod after a period of use to reflect the change in the level of the pod as a result of that use.

Having inserted the pod, the user may proceed to use the non-combustible aerosol provision system 10, the non-combustible aerosol provision system 10 thereby generating aerosols using the aerosolisable material from the pod. Thus, the level of aerosolisable material in the pod is reduced. At step S47, an input indicative of a change in the supply of aerosolisable material is received. This change in supply may be measured by the non-combustible aerosol provision system 10 itself by monitoring the amount of aerosolisable material drawn from the pod or calculated based on usage characteristics of the device. For example, the amount of aerosolisable material may be calculated (by the non-combustible aerosol provision system or the user device) based on a number of puffs taken by the user, a heater power level of the non-combustible aerosol provision system, a length of the puffs taken by the user and any other relevant factors impacting the consumption of aerosolisable material.

On the basis of this change in the supply of aerosolisable material, the stored indication of the inventory being maintained can be updated at step S48 (corresponding to step S39 of FIGS. 3 and 4). Additionally or alternatively, at step S49, an updated level of aerosolisable material in the pod can be written back to the storage element of the pod. By updating the storage element of the pod with the new level of aerosolisable material in this way, the non-combustible aerosol provision system 10 is able to maintain an accurate indication of the level of aerosolisable material in the pod on the storage element. This can be helpful in managing the user's inventory of aerosolisable material particularly if the pods are used between more than device.

At step S50, as shown in FIG. 5, the non-combustible aerosol provision system 10 detects removal of the pod. This may be achieved for example by the breaking of a circuit completed by the pod, a change in resistance or by a contact switch.

Where pods which can store a current level of aerosolisable material are used, there may be an additional safety functionality provided to detect if a non-refillable pod has been refilled. This functionality utilises both the details of the pod's current level of aerosolisable material and a unique identifier to enable the pod to be separately identified relative to all other pods in the user inventory. As the inventory tracking can keep track of the inventory quantity (i.e. last read or written current level of aerosolisable material for the pod) as specific to that particular pod identifier, then if at a future occasion the amount of aerosolisable material remaining exceeds a previously read or written current level of aerosolisable material for that pod, then a refill action may be detected. When a refill action of a non-refillable pod is detected, the user can be alerted or the non-combustible aerosol provision system may prevent the pod being used for safety reasons.

Thus there has been described an approach by which a pod which stores a value representing a remaining amount of aerosolisable material therein can be read to discover an initial amount of aerosolisable material, and later (after usage of a non-combustible aerosol provision system in which the pod has been inserted has caused a reduction in the remaining amount of aerosolisable material in the pod) have an updated amount of aerosolisable material written to the pod. Thus a pod-level inventory tracking may be performed where individual pod inventory can be tracked either as representative of a total inventory under consideration or as part of a wider inventory tracking based upon multiple pods in the inventory.

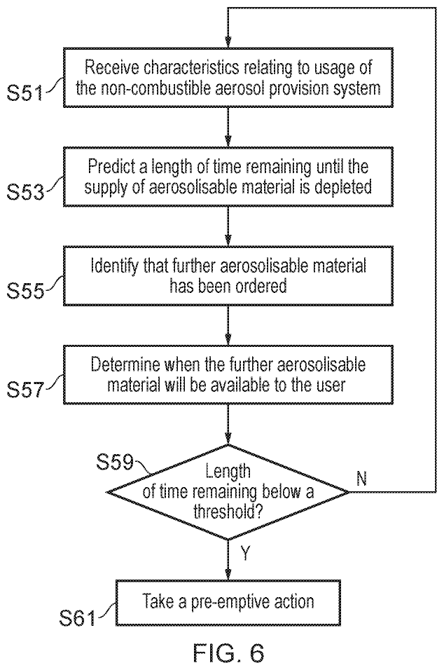

FIG. 6 is a flowchart illustrating a method of managing a supply of aerosolisable material for a non-combustible aerosol provision system. As used herein, the supply may be the user's inventory of aerosolisable material (e.g., an amount of aerosolisable material stored across a plurality of pods, a number of pods of aerosolisable material, or an amount of aerosolisable material available for use with refillable pods). In some cases, the supply of aerosolisable material may relate to other quantities of aerosolisable material such as the level of aerosolisable material remaining in a particular pod or the amount of aerosolisable material currently available to the user (e.g., an amount that the user has with them where the inventory may also include aerosolisable the user has in another location).

At step S51 of FIG. 6, characteristics relating to usage of the non-combustible aerosol provision system 10 are received. These characteristics may be received from the user themself through user input specifying the characteristics. For example, the user may enter at the user device a change in the supply of aerosolisable material which may represent one or more pods that the user has given away/lost, a correction to a stored indication of the user's supply of aerosolisable material, or an amount of aerosolisable material consumed in a session of use.

The characteristics relating to usage could also be provided by the non-combustible aerosol provision system 10. This may be useful since it avoids the user having to track their own usage. For example, the non-combustible aerosol provision system 10 may detect one or more puffs on the non-combustible aerosol provision system and collect usage characteristics for the one or more puffs such as length of the puffs, a number of puffs taken, and/or a heater power level of the non-combustible aerosol provision system 10. The non-combustible aerosol provision system 10 can then provide these characteristics to the user device 40 for use in predicting a length of time remaining until the supply of aerosolisable material is depleted.

In some examples, the non-combustible aerosol provision system 10 is operable in an auto-draw mode as explained above and provides as the characteristics relating to usage of the non-combustible aerosol provision system 10, the details of the puffs detected, the amount of aerosolisable material consumed when operating in response to those puffs, or parameters of the operation of the non-combustible aerosol provision system 10 set based on those puffs.

Having received the characteristics, a length of time remaining until the supply of aerosolisable material is depleted is calculated at step S53. The calculation performed will depend on the characteristics received, but may for example involve determining an average rate of consumption of aerosolisable material over a recent time period and projecting this rate of consumption forwards to determine the length of time remaining. The calculation may take into account other factors such as the heater power level. Since the heater power level may be related to the rate at which aerosolisable material is consumed, by additionally accounting for a current heater power setting, a more accurate prediction of the length of time remaining may be obtained.

In some examples, the prediction of the length of time remaining also takes into account the user's usage patterns of the non-combustible aerosol provision system based on their past use. This means that the prediction can be tailored to the user and account for individual variation in how he/she uses the device.

In some cases, this involves detecting and making use of a user's average puff duration, an average number of puffs a user takes in a session, a typical heater power level selection of the user, and/or the number of sessions performed over a given time period. By making use of typical values of these quantities for the user, a more accurate prediction of the time remaining until the supply of aerosolisable material is depleted may be obtained.

The method may also take into account the user's usage patterns by developing a profile of the user's usage throughout the day or week. For instance, the usage characteristics may indicate that a user tends to use the non-combustible aerosol provision system 10 only a small amount in the morning but then a large amount in the afternoon. By incorporating this information into the prediction, the prediction can account for a user's typical variation in consumption throughout the day.

As discussed, to calculate the predicted length of time remaining at step S53, the characteristics relating to usage are used. This calculation additionally depends on the initial supply of aerosolisable material with the usage characteristics used to determine an expected amount of time for that supply to be depleted. The initial supply can be obtained from a number of sources, but in some examples, the initial supply is input by the user, read from a storage element on a pod, or retrieved from a stored indication of the supply.

In some examples, the supply is considered to be depleted when no more aerosolisable material is left. That is, depletion of the supply corresponds to using all of the material. However, in some examples, the aerosolisable material may be considered depleted at a different level, for example, once the level of aerosolisable material has reached a threshold level.

The predicted length of time remaining may be displayed to the user at this point, or used to inform another calculation. In the example of FIG. 6 however, at step S55 it is identified that further aerosolisable material has been ordered. This determination may be made on the basis of an indication from the user, an order placed within an app on the user device, detection that an account associated with the user has been used to order more aerosolisable material, or may be in response to automatic ordering of the aerosolisable material by the user device 40.

It is then determined at step S57, when the further aerosolisable material will be available to the user, e.g., by identifying an estimated delivery date for the order.

Following this, at step S59, the predicted length of time remaining is compared to a threshold length of time. The further aerosolisable material ordered and the time at which this material will be available may be used to set the level of the threshold. For example, if the length of time remaining with the current supply of aerosolisable material is long enough for the further aerosolisable material to arrive, it may be determined that the supply of aerosolisable material is sufficient.

It will be appreciated that in some cases, further aerosolisable material may not have been ordered (such that optional steps S55 and S57 are omitted) and so this additional factor will not be used when comparing the predicted time remaining with the threshold. Instead, a threshold amount of time may be set below which a pre-emptive action will be triggered at step S61. If the predicted length of time remaining falls below the threshold length of time (e.g., the supply of aerosolisable material is not sufficient to last the day/week), this pre-emptive action may be triggered to reduce the likelihood of running out of aerosolisable material or to alert the user.

The pre-emptive action could take a number of possible forms depending on the perceived severity of the length of time remaining falling below the threshold, the capabilities of the user device and non-combustible aerosol provision system and the user's preferences.

For example, the pre-emptive action may comprise notifying a user of the non-combustible aerosol provision system 10 that the predicted length of time remaining is below the threshold. The user could then take an appropriate action to reduce their consumption or obtain more aerosolisable material for example. Notifying the user may comprise issuing a notification via the output device 50 of the user device. Similarly, the pre-emptive action may comprise displaying the predicted length of time remaining to the user (e.g., on an output device 50 of the user device 40).

In some examples, in order to extend the length of time remaining until the supply of aerosolisable material is depleted, the pre-emptive action involves causing the non-combustible aerosol provision system 10 to enter an aerosolisable material conserving mode in which aerosolisable material is consumed at a slower rate than when in one or more other modes of the system. This approach therefore increases the length of time remaining until the supply of aerosolisable material is depleted, potentially providing enough time for more aerosolisable material to be obtained. Examples of operational properties of the non-combustible aerosol provision system that could be altered to achieve an aerosolisable material conserving mode include a heater power setting and a puff duration limit, thereby to reduce the rate of depletion of the aerosolisable material while the aerosolisable material conserving mode is in effect.

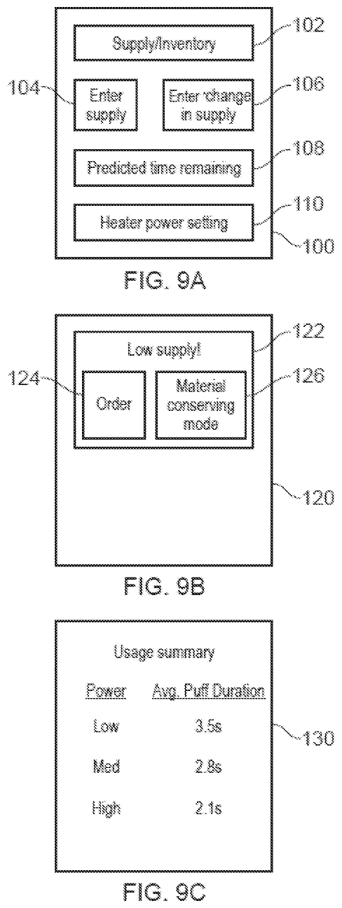

Another pre-emptive action that may be taken involves ordering more aerosolisable material. This could be done automatically in response to the length of time remaining falling below the threshold or the user may be prompted to order more aerosolisable material. This prompt may be issued to the user in combination with notifying the user that the length of time remaining has fallen below the threshold, as illustrated in FIG. 9B and described in more detail with reference thereto.

It will be appreciated that more than one of these pre-emptive actions may be taken (e.g., notifying the user and ordering more aerosolisable material). By taking these pre-emptive actions, the likelihood of a user running out of aerosolisable material and being unable to use the device may be reduced and the user afforded control and oversight over their supply of aerosolisable material.

Thus there has been described an approach in which a remaining time to depletion of aerosolisable material of a user inventory (or indeed a single pod) can be tracked and one or more appropriate actions taken responsive to such depletion reaching a threshold. Thus an almost real-time update to the remaining inventory can be made, such as to enable user notification and/or other appropriate action to be taken without delay such as to avoid total inventory depletion before a next inventory restocking event.

FIG. 7 is a method of tracking usage of aerosolisable material for a non-combustible aerosol provision system. As shown in FIG. 7, at step S71 the non-combustible aerosol provision system 10 detects a puff or a session comprising one or more puffs on the non-combustible aerosol provision system 10. This may act as a trigger for the non-combustible aerosol provision system 10 to collect, at step S73, usage characteristics indicative of how the user is using the device. The usage characteristics may comprise, a duration of a puff taken on the non-combustible aerosol provision system, a number of puffs taken in the session of use before the user stops using the device for an extended period, an amount of aerosolisable material consumed in using the non-combustible aerosol provision system, a time at which the non-combustible aerosol provision system was used, and/or an identifier of a pod type/property present in the non-combustible aerosol provision system. The non-combustible aerosol provision system 10 may also or alternatively be operable in the auto-draw mode described above. Where this is the case, the usage characteristics may comprise the details of the puffs detected, the amount of aerosolisable material consumed when operating in response to those puffs, or parameters of the operation of the non-combustible aerosol provision system 10 set based on those puffs.

Having collected the information on these characteristics, the non-combustible aerosol provision system 10 communicates (e.g., via Bluetooth™ or other appropriate connectivity protocol) the usage characteristics to the user device 40. The non-combustible aerosol provision system 10 may provide the usage characteristics to the user device 40 as the characteristics are recorded to provide the user device 40 with up-to-date information regarding the use of the non-combustible aerosol provision system. However, in some examples, the non-combustible aerosol provision system 10 collects a set of usage characteristics (e.g., corresponding to a session of use or a particular period of time) and provides the collection of usage characteristics to the user device 40 together, thereby reducing the power consumption involved in maintaining communication between the non-combustible aerosol provision system 10 and the user device 40.

Having received the usage characteristics at step S79, the user device is configured to calculate a usage summary based at least in part on the usage characteristics. The usage summary may be provided to the user to give the user insight into how they use the non-combustible aerosol provision system 10 or may for example be used to determine a rate of consumption of aerosolisable material.

The usage summary can take a number of forms and may depend on the usage characteristics provided. In one example however, the usage characteristics indicate that the time at which the non-combustible aerosol provision system 10 is used from which the user device 40 is able to determine a usage summary that indicates a user's typical profile of use throughout the day. This may be helpful for the user to understand how and when they tend to use the non-combustible aerosol provision system 10. For example, where the non-combustible aerosol provision system 10 is operable with pods of different types and the type of pod can be identified by the non-combustible aerosol provision system 10, the usage summary may indicate a type of pod that the user typically uses during certain periods of the day (e.g., mint flavoured pods in the morning and mango flavoured pods in the afternoon).

Similarly, where the non-combustible aerosol provision system 10 is operable with a plurality of heater power levels, the usage summary may indicate which of the heater power levels the user uses at different times of the day. In another example, the usage summary identifies how a typical number of puffs taken by a user in a session of use varies for different periods of the day. In this way, the user can track whether they use the non-combustible aerosol provision system 10 more at certain points than at others.

Another useful metric for tracking the use of the non-combustible aerosol provision system 10 may involve how the duration of the puffs taken by the user varies with the heater power level of the non-combustible aerosol provision system 10. Where the usage characteristics identify a duration of one or more puffs on the non-combustible aerosol provision system and a heater power level, the usage summary may indicate, as a typical profile of use, an average duration of puff for each of a plurality of heater power levels.

Thus from one perspective, the usage summary may be considered as being representative of a typical usage profile. Such a profile may take into account a wide range of possible data about usage of the non-combustible aerosol provision system. Where the approaches relate to multiple non-combustible aerosol provision systems of a user, the usage profile may be made applicable to just one or a subset of non-combustible aerosol provision systems of the user, or to all non-combustible aerosol provision systems of the user.

Based on the usage summary, the user device 40 may calculate an expected amount of aerosolisable material to be used during an upcoming period at step S83. By basing this calculation on the usage summary as determined for the usage characteristics, a tailored estimate of the expected amount of aerosolisable material can be derived taking into account how the user uses the non-combustible aerosol provision system, thereby increasing the accuracy of the calculation.

In a similar manner to that discussed previously and as illustrated in step S85 of FIG. 7, the calculation of the expected amount of aerosolisable material consumed can be used to calculate a predicted inventory of aerosolisable material following the upcoming period. This may be displayed to a user to inform him/her of how the inventory of aerosolisable material is expected to vary. As illustrated in FIG. 7 however, the predicted inventory is compared to a threshold at step S87 with a pre-emptive action being taken at step S89 if the predicted level of the inventory is below the threshold.

As discussed above, the pre-emptive action could take a number of forms, for example, notifying the user, prompting the user to order more aerosolisable material, ordering more aerosolisable material on behalf of the user, or causing the non-combustible aerosol provision system to enter an aerosolisable material conserving mode.

Thus there has been describe an approach in which usage of one or more non-combustible aerosol provision systems can be monitored so as to provide either or both of a detailed summary of the usage and a more precise tracking of consumption of aerosolisable material (such as pods, other consumables and/or refill stock) of the non-combustible aerosol provision system.

FIGS. 8A-8E illustrate example inventories of aerosolisable material and the corresponding indications of the inventory that could be maintained in accordance with the techniques described herein.

As shown in FIG. 8A, the user's inventory comprises three pods of aerosolisable material 62, 64, 66 which are indistinguishable from one another. That is, the non-combustible aerosol provision system 10 is not able to separately identify the three pods. In this case, one of the pods 62 is 50% full whereas the other two pods 64, 66 are full. Since the non-combustible aerosol provision system 10 cannot separately distinguish the pods, an indication of the inventory (or the supply of aerosolisable material) is maintained to indicate a total amount of aerosolisable material across all of the pods available to the user. In this case, therefore the inventory comprises 2.5 pods' worth of aerosolisable material. Here, the capacity of a pod is used as a unit to indicate the quantity of aerosolisable material, however, it will be appreciated that the inventory could be represented in other ways (e.g., in millilitres).

FIG. 8B shows another example of a user's inventory in which two types of pods are present. In this example, the types of pod represent different flavours of aerosolisable material, mint and mango. As shown in FIG. 8B, the inventory comprises three mint pods 68, 70, 72 of which one is 50% full and the others are full, and two mango pods 74, 76 of which one is 70% full and the other is full. The non-combustible aerosol provision system 10 is able to distinguish between these different types of pod and so can ascribe a separate level of supply to each type of pod. As shown, the inventory therefore indicates that there are 2.5 pods of mint aerosolisable material and 1.7 pods of mango aerosolisable material. As will be appreciated, other specific types of pods may be detected in this arrangement. Examples in which a type of pod may be identifiable can include an arrangement in which each pod has a detectable pod type characteristic which can be read by a non-combustible aerosol provision system when the pod is inserted into the non-combustible aerosol provision system. For example, due to electrical contacts on the pod completing a circuit and being detected by the non-combustible aerosol provision system, and/or by information provided by an RFID/NFC communication possibility with the pod.

As illustrated in FIG. 8C, the pods are all separately identifiable by the non-combustible aerosol provision system 10 and so a separate indication of the amount of aerosolisable material in each pod can be maintained. In this example, pod 1 78 is 80% full, pod 2 80 is full and pod 3 82 is 30% full. Maintaining a separate indication of the supply for each pod in this way may provide the user with a more complete or more accurate understanding of their inventory on a more granular level. Examples in which each pod may be separately identifiable can include an arrangement in which each pod has a unique pod characteristic which can be read by a non-combustible aerosol provision system when the pod is inserted into the non-combustible aerosol provision system. For example, this could be due to a specific electrical response being provided by electrical contacts when connected to the non-combustible aerosol provision system, and/or by information provided by an RFID/NFC communication possibility with the pod.

FIG. 8D illustrates an example in which refillable pods of aerosolisable material are used. In this case, the refillable pod 84 stores aerosolisable material which can be topped up from a reservoir 86 of refill material. In this case, inventory may track an amount of aerosolisable material in the refillable pod 84 and the reservoir 86. As shown in FIG. 8D, this corresponds to a total of five refills of the refillable pod.

Where refillable pods are used, the techniques described herein may also be used to track a lifetime of the pod. Since the refillable pods may have an associated maximum number of refill cycles before the pod should be replaced, by tracking the amount of aerosolisable material consumed from that pod, the number of refills of the pod can estimated. Hence, if the number of refills exceeds the allowable number of refill cycles, the user can be alerted or the non-combustible aerosol provision system 10 may prevent the pod being used for safety reasons.

FIG. 8E illustrates an example in which more than one inventory is maintained. In this example, three separate indications of the inventory are maintained to represent a user's total supply of aerosolisable material, a supply of aerosolisable material that the user has with them on a trip and a supply of aerosolisable material that the user has at home (or other location such as stored in a vehicle or at a work location). As shown, a separate indication of the inventory is maintained for each of these three inventories. In order to maintain the inventories in this way, the non-combustible aerosol provision system 10 and/or the user device 40 may be responsive to input indicative of an amount of aerosolisable material (or a change in the amount) to identify to which inventory the input relates, and then update the relevant inventory. Maintaining more than one inventory in this way provides added flexibility since more than one supply of aerosolisable material can be tracked in cases where not all of the inventory is available to the user at the same time (e.g., where some of the supply is with the user on a trip and some has been left at home). As will be appreciated, either or both of the “on trip” and “at home” inventories may be managed according to the approach shown in any of FIG. 8A, 8B, 8C or 8D according to the extent to which any pods are or are not individually identifiable.

FIGS. 9A-9C are schematics illustrating user interfaces used in managing a supply of aerosolisable material for a non-combustible aerosol provision system.

FIG. 9A illustrates a user interface 100 comprising a supply/inventory indication 102 to display to a user the amount of supply/inventory available. For example, the indication 102, may display that the user has a given number of pods left or that the pod currently being used is a given percentage full.

The user interface 100 also comprises elements 104, 106 by which a user can enter a supply of aerosolisable material or a change in the supply of aerosolisable material, with this user input used to update a stored indication of the supply. The user interface 100 further comprises an element 108 to indicate a predicted time remaining until the supply of aerosolisable material is depleted and a heater power level element 110 to display the current heater power level and allow the user to select a heater power level for the non-combustible aerosol provision system 10.

FIG. 9B illustrates a user interface 120 with a notification 122 to the user that they are running low on aerosolisable material. This may be displayed as pre-emptive action in response to determining that the inventory of aerosolisable material is below a threshold or that a predicted remaining time until the aerosolisable material is depleted is below a threshold, for example. As shown in FIG. 9B, the notification may inform the user of the status of the inventory/supply as well as prompt the user to order more aerosolisable material with an order button 124 or switch the non-combustible aerosol provision system 10 to an aerosolisable material conserving mode with button 126.

FIG. 8C illustrates a user interface 130 with an example usage summary. In this example the usage summary indicates for each of a plurality of heater power levels, (low, medium and high), an average duration of puff that the user takes when the non-combustible aerosol provision system 10 is operating at that level.

Thus a number of user interface approaches have been illustrated to represent a manner in which a user may interact with a user device to discover, set and receive notifications about usage of the user's non-combustible aerosol provision system(s).

As has been indicated above, the techniques described herein may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media such as carrier signals and transmission media. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. The term “computer-readable storage media” refers to physical storage media. Transient communication media may occur between components of a single computing system (e.g. on an internal link or bus between e.g. a memory and processor) or between separate computing systems (e.g. over a network or other inter-computing device connection), and may include transmission signals, carrier waves or the like.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

### CLAUSES

Clause 1. A method for managing a supply of aerosolisable material for a non-combustible aerosol provision system comprising:
   receiving one or more characteristics relating to usage of the non-combustible aerosol provision system;
   predicting a length of time remaining until the supply of aerosolisable material is depleted based on the one or more characteristics relating to usage and an initial supply of aerosolisable material; and
   taking a pre-emptive action before the supply of aerosolisable material is depleted.
Clause 2. The method according to clause 1, wherein:
   the pre-emptive action comprises notifying a user of the non-combustible aerosol provision system.
Clause 3. The method according to clause 1 or clause 2, wherein:
   the pre-emptive action comprises causing the non-combustible aerosol provision system to enter an aerosolisable material conserving mode.
Clause 4. The method according to any preceding clause, wherein:
   the pre-emptive action comprises prompting a user to order more aerosolisable material.
Clause 5. The method according to any preceding clause, wherein:
   the pre-emptive action comprises ordering more aerosolisable material on behalf of the user.
Clause 6. The method according to any preceding clause, wherein:
   the pre-emptive action comprises displaying the predicted length of time remaining.
Clause 7. The method according to any preceding clause, wherein:
   the supply of aerosolisable material is at least one of:
      an amount of aerosolisable material stored across a plurality of pods;
      an amount of aerosolisable material stored in a particular pod;
      a number of pods of aerosolisable material; and
      an amount of aerosolisable material available for use with refillable pods.
Clause 8. The method according to any preceding clause, the method further comprising:
   determining whether the length of time remaining is below a threshold;
   wherein taking the pre-emptive action is in response to determining that the length of time remaining is below the threshold.
Clause 9. The method according to any preceding clause, wherein:
   the non-combustible aerosol provision system is operable at a plurality of heater power settings; and
   the one or more characteristics relating to usage comprise a current heater power heater power setting.
Clause 10. The method according to any preceding clause, wherein:
   the one or more characteristics relating to usage comprise a user's usage patterns of the non-combustible aerosol provision system based on the user's past use of the non-combustible aerosol provision system.
Clause 11. The method according to clause 10, wherein:
   the one or more characteristics relating to usage comprise at least one of:
      the user's average puff duration;
      the user's typical heater power level selection; and
      a typical number of puffs taken by a user in a session of use of the non-combustible aerosol provision system.
Clause 12. The method according to any preceding clause, wherein:
   the one or more characteristics relating to usage comprise puff information about one or more puffs on the non-combustible aerosol provision system taken by the user.
Clause 13. The method according to clause 12, wherein:
   the puff information comprises at least one of:
      a length of puff;
      a number of puffs taken by the user; and
   a heater power level of the non-combustible aerosol provision system when the one or more puffs were taken.
Clause 14. The method according to any preceding clause, wherein:
   the initial supply is determined based on a stored indication of a user's inventory of aerosolisable material.
Clause 15. The method according to any preceding clause, the method further comprising:
   receiving an input from a user indicative of the initial supply of aerosolisable material.
Clause 16. The method according to any of clauses 1-13, the method further comprising:
   detecting the initial supply of aerosolisable material from a storage element of a pod.
Clause 17. The method according to any preceding clause, wherein:
   the one or more characteristics relating to usage comprise a change in the supply of aerosolisable material indicated by a user.
Clause 18. The method according to any preceding clause, the method further comprises:
   identifying that further aerosolisable material has been ordered; and
   determining when the further aerosolisable material will be available to the user;
   wherein determining whether the length of time remaining is below the threshold is based on the further aerosolisable material and when the further aerosolisable material will be available.
Clause 19. A user device comprising:
   a receiver/transmitter element to receive one or more characteristics relating to usage of a non-combustible aerosol provision system; and
   a processor configured to:
      predict a length of time remaining until the supply of aerosolisable material is depleted based on the one or more characteristics relating to usage and an initial supply of aerosolisable material; and
      take a pre-emptive action before the supply of aerosolisable material is depleted.
Clause 20. The user device according to clause 19, wherein:
   the pre-emptive action comprises notifying a user of the non-combustible aerosol provision system.
Clause 21. The user device according to clause 19 or clause 20, wherein:
   the pre-emptive action comprises causing the non-combustible aerosol provision system to enter an aerosolisable material conserving mode.
Clause 22. The user device according to any of clauses 19-21, wherein:
   the pre-emptive action comprises prompting a user to order more aerosolisable material.
Clause 23. The user device according to any of clauses 19-22, wherein:
   the pre-emptive action comprises ordering more aerosolisable material on behalf of the user.
Clause 24. The user device according to any of clauses 19-23, wherein:
   the pre-emptive action comprises displaying the predicted length of time remaining.
Clause 25. The user device according to any of clauses 19-24, wherein:
   the supply of aerosolisable material is at least one of:
      an amount of aerosolisable material stored across a plurality of pods;
      an amount of aerosolisable material stored in a particular pod;
      a number of pods of aerosolisable material; and
      an amount of aerosolisable material available for use with refillable pods.
Clause 26. The user device according to any of clauses 19-25, the processor further configured to:
   determine whether the length of time remaining is below a threshold;
   wherein taking the pre-emptive action is in response to determining that the length of time remaining is below the threshold.
Clause 27. The user device according to any of clauses 19-26, wherein:
   the non-combustible aerosol provision system is operable at a plurality of heater power settings; and
   the one or more characteristics relating to usage comprise a current heater power heater power setting.
Clause 28. The user device according to any of clauses 19-27, wherein:
   the one or more characteristics relating to usage comprise a user's usage patterns of the non-combustible aerosol provision system based on the user's past use of the non-combustible aerosol provision system.
Clause 29. The user device according to clause 28, wherein:
   the one or more characteristics relating to usage comprise at least one of:
      the user's average puff duration;
      the user's typical heater power level selection; and
      a typical number of puffs taken by a user in a session of use of the non-combustible aerosol provision system.
Clause 30. The user device according to any of clauses 19-29, wherein:
   the one or more characteristics relating to usage comprise puff information about one or more puffs on the non-combustible aerosol provision system taken by the user.
Clause 31. The user device according to clause 30, wherein:
   the puff information comprises at least one of:
      a length of puff;
      a number of puffs taken by the user; and
   a heater power level of the non-combustible aerosol provision system when the one or more puffs were taken.
Clause 32. The user device according to any of clauses 19-31, wherein:
   the initial supply is determined based on a stored indication of a user's inventory of aerosolisable material.
Clause 33. The user device according to any of clauses 19-32, the processor further configured to:
   receive an input from a user indicative of the initial supply of aerosolisable material.
Clause 34. The user device according to any of clauses 19-31, the receiver/transmitter element is further to:
   receive an initial supply of aerosolisable material detected from a storage element of a pod.
Clause 35. The user device according to any of clauses 19-34, wherein:
   the one or more characteristics relating to usage comprise a change in the supply of aerosolisable material indicated by a user.
Clause 36. The user device according to any of clauses 19-35, the processor further configured to:
   identify that further aerosolisable material has been ordered; and
   determine when the further aerosolisable material will be available to the user;
   wherein determining whether the length of time remaining is below the threshold is based on the further aerosolisable material and when the further aerosolisable material will be available.
Clause 37. A computer-readable medium comprising instructions which, when executed by processing circuitry of a computing device, cause the computing device to:
   receive one or more characteristics relating to usage of the non-combustible aerosol provision system;
   predict a length of time remaining until the supply of aerosolisable material is depleted based on the one or more characteristics relating to usage and an initial supply of aerosolisable material; and
   take a pre-emptive action before the supply of aerosolisable material is depleted.
Clause 38. The computer-readable medium according to clause 37, wherein:
   the pre-emptive action comprises notifying a user of the non-combustible aerosol provision system.
Clause 39. The computer-readable medium according to clause 37 or clause 38, wherein:
   the pre-emptive action comprises causing the non-combustible aerosol provision system to enter an aerosolisable material conserving mode.
Clause 40. The computer-readable medium according to any of clauses 37-39, wherein:
   the pre-emptive action comprises prompting a user to order more aerosolisable material.
Clause 41. The computer-readable medium according to any of clauses 37-40, wherein:
   the pre-emptive action comprises ordering more aerosolisable material on behalf of the user.
Clause 42. The computer-readable medium according to any of clauses 37-41, wherein:
   the pre-emptive action comprises displaying the predicted length of time remaining.
Clause 43. The computer-readable medium according to any of clauses 37-42, wherein:
   the supply of aerosolisable material is at least one of:
      an amount of aerosolisable material stored across a plurality of pods;
      an amount of aerosolisable material stored in a particular pod;
      a number of pods of aerosolisable material; and
      an amount of aerosolisable material available for use with refillable pods.
Clause 44. The computer-readable medium according to any of clauses 37-43, the instructions further to cause the processing circuitry to:
   determine whether the length of time remaining is below a threshold;
   wherein taking the pre-emptive action is in response to determining that the length of time remaining is below the threshold.
Clause 45. The computer-readable medium according to any of clauses 37-44, wherein:
   the non-combustible aerosol provision system is operable at a plurality of heater power settings; and
   the one or more characteristics relating to usage comprise a current heater power heater power setting.
Clause 46. The computer-readable medium according to any of clauses 37-45, wherein:
   the one or more characteristics relating to usage comprise a user's usage patterns of the non-combustible aerosol provision system based on the user's past use of the non-combustible aerosol provision system.
Clause 47. The computer-readable medium according to clause 46, wherein:
   the one or more characteristics relating to usage comprise at least one of:
      the user's average puff duration;
      the user's typical heater power level selection; and
      a typical number of puffs taken by a user in a session of use of the non-combustible aerosol provision system.
Clause 48. The computer-readable medium according to any of clauses 37-47, wherein:
   the one or more characteristics relating to usage comprise puff information about one or more puffs on the non-combustible aerosol provision system taken by the user.
Clause 49. The computer-readable medium according to clause 48, wherein:
   the puff information comprises at least one of:
      a length of puff;
      a number of puffs taken by the user; and
   a heater power level of the non-combustible aerosol provision system when the one or more puffs were taken.
Clause 50. The computer-readable medium according to any of clauses 37-49, wherein:
   the initial supply is determined based on a stored indication of a user's inventory of aerosolisable material.
Clause 51. The computer-readable medium according to any of clauses 37-50, the instructions further to cause the computing device to:
   receive an input from a user indicative of the initial supply of aerosolisable material.
Clause 52. The computer-readable medium according to any of clauses 37-49, the instructions further to cause the computing device to:
   detect the initial supply of aerosolisable material from a storage element of a pod.
Clause 53. The computer-readable medium according to any of clauses 37-52, wherein:
   the one or more characteristics relating to usage comprise a change in the supply of aerosolisable material indicated by a user.
Clause 54. The computer-readable medium according to any of clauses 37-53, the instructions further to cause the computing device to:
   identify that further aerosolisable material has been ordered; and determine when the further aerosolisable material will be available to the user;
Clause 55. wherein determining whether the length of time remaining is below the threshold is based on the further aerosolisable material and when the further aerosolisable material will be available.
Clause 56. A method comprising:
   receiving usage characteristics from a non-combustible aerosol provision system; and
   calculating a usage summary based at least in part on the usage characteristics.
Clause 57. The method according to clause 56, wherein:
   the usage characteristics relate to a single puff on the non-combustible aerosol provision system by a user.
Clause 58. The method according to clause 56, wherein:
   the usage characteristics relate to a plurality of puffs on the non-combustible aerosol provision system by a user.
Clause 59. The method according to any of clauses 56-58, wherein:
   the usage characteristics comprise at least one of:
      a puff duration of a puff on the non-combustible aerosol provision system;
      a number of puffs taken in a session of use;
      an amount of aerosolisable material consumed in using the non-combustible aerosol provision system; and
      a time at which the non-combustible aerosol provision system was used.
Clause 60. The method according to any of clauses 56-59, wherein:
   the usage characteristics identify when the non-combustible aerosol provision system was used; and
   calculating the usage summary comprises calculating a user's typical profile of use across a day.
Clause 61. The method according to clause 60, wherein:
   the usage characteristics further identify a type of pod being used with the non-combustible aerosol provision system; and
   calculating the typical profile of use comprises identifying, for one or more periods of the day, which type of pod the user typically uses during that period.
Clause 62. The method according to any of clause 60 to clause 61, wherein:
   the usage characteristics further identify a heater power level of the non-combustible aerosol provision system; and
   calculating the typical profile of use comprises identifying, for one or more periods of the day, which of a plurality of heater power levels supported by the non-combustible aerosol provision system, the user typically uses during that period.
Clause 63. The method according to any of clause 60 to clause 62, wherein:
   the usage characteristics further identify a number of puffs taken in a session of use of the non-combustible aerosol provision system; and
   calculating the typical profile of use comprises identifying, for one or more period of the day, a typical number of puffs taken by the user in a session of use.
Clause 64. The method according to any of clauses 56-63, wherein:
   the usage characteristics identify a duration of one or more puffs on the non-combustible aerosol provision system taken by the user and a heater power level of the non-combustible aerosol provision system; and
   calculating the usage summary comprises determining an average duration of a puff on the non-combustible aerosol provision system for each of a plurality of heater power level supported by the non-combustible aerosol provision system.
Clause 65. The method according to any of clauses 56-64, wherein:
   the usage characteristics are received via Bluetooth.
Clause 66. The method according to any of clauses 56-65, the method further comprising:
   displaying the usage summary to the user.
Clause 67. The method according to any of clauses 56-66, the method further comprising:
   calculating, based on the usage characteristics, an amount of aerosolisable material consumed by the non-combustible aerosol provision system during a period of use to which the usage characteristics relate.
Clause 68. The method according to any of clauses 56-67, the method further comprising:
   calculating, based on the usage summary, an expected amount of aerosolisable material to be used during an upcoming period.
Clause 69. The method according to clause 68, the method further comprising:
   calculating, based on the expected amount of aerosolisable material to be used and a stored indication of a user's inventory of aerosolisable material, a predicted inventory of aerosolisable material following the upcoming period; and
   taking, when the predicted inventory of aerosolisable material following the upcoming period is below a threshold, a pre-emptive action.
Clause 70. The method according to clause 69, wherein:
   the pre-emptive action comprises at least one of:
      notifying the user;
      prompting the user to order more aerosolisable material;
      ordering more aerosolisable material on behalf of the user; and
      causing the non-combustible aerosol provision system to enter an aerosolisable material conserving mode.
Clause 71. A non-combustible aerosol provision system comprising:
   a control unit configured to collect usage characteristics for the non-combustible aerosol provision system; and
   a communication element to communicate the usage characteristics to a user device.
Clause 72. The non-combustible aerosol provision system according to clause 36, wherein
   the control unit is configured to detect a puff on the non-combustible aerosol provision system and to collect the usage characteristics in response to detecting the puff.
Clause 73. The non-combustible aerosol provision system according to clause 36 or clause 37, wherein:
   the communication element is a Bluetooth communication element to communicate the usage characteristics to the user device via Bluetooth.
Clause 74. A user device comprising:
   a receiver element to receive usage characteristics from a non-combustible aerosol provision system; and
   a processor to calculate a usage summary based at least in part on the usage characteristics.
Clause 75. The user device according to clause 74, wherein:
   the usage characteristics relate to a single puff on the non-combustible aerosol provision system by a user.
Clause 76. The user device according to clause 74, wherein:
   the usage characteristics relate to a plurality of puffs on the non-combustible aerosol provision system by a user.
Clause 77. The user device according to any of clauses 74-76, wherein:
   the usage characteristics comprise at least one of:
      a puff duration of a puff on the non-combustible aerosol provision system;
      a number of puffs taken in a session of use;
      an amount of aerosolisable material consumed in using the non-combustible aerosol provision system; and
      a time at which the non-combustible aerosol provision system was used.
Clause 78. The user device according to any of clauses 74-77, wherein:
   the usage characteristics identify when the non-combustible aerosol provision system was used; and
   calculating the usage summary comprises calculating a user's typical profile of use across a day.
Clause 79. The user device according to clause 78, wherein:
   the usage characteristics further identify a type of pod being used with the non-combustible aerosol provision system; and
   to calculate the typical profile of use, the processor is configured to identify, for one or more periods of the day, which type of pod the user typically uses during that period.
Clause 80. The user device according to any of clause 78 to clause 79, wherein:
   the usage characteristics further identify a heater power level of the non-combustible aerosol provision system; and
   to calculate the typical profile of use, the processor is configured to identify, for one or more periods of the day, which of a plurality of heater power levels supported by the non-combustible aerosol provision system, the user typically uses during that period.
Clause 81. The user device according to any of clauses 78-80, wherein:
   the usage characteristics further identify a number of puffs taken in a session of use of the non-combustible aerosol provision system; and
   to calculate the typical profile of use, the processor is configured to identify, for one or more period of the day, a typical number of puffs taken by the user in a session of use.
Clause 82. The user device according to any of clauses 78-81, wherein:
   the usage characteristics identify a duration of one or more puffs on the non-combustible aerosol provision system taken by the user and a heater power level of the non-combustible aerosol provision system; and
   to calculate the usage summary, the processor is configured to determine an average duration of a puff on the non-combustible aerosol provision system for each of a plurality of heater power level supported by the non-combustible aerosol provision system.
Clause 83. The user device according to any of clauses 74-82, wherein:
   the usage characteristics are received via Bluetooth.
Clause 84. The user device according to any of clauses 74-83, user device further configured to:
   display the usage summary to the user.
Clause 85. The user device according to any of clauses 74-84, the processor further configured to:
   calculate, based on the usage characteristics, an amount of aerosolisable material consumed by the non-combustible aerosol provision system during a period of use to which the usage characteristics relate.
Clause 86. The user device according to any of clauses 74-85, the processor further configured to:
   calculate, based on the usage summary, an expected amount of aerosolisable material to be used during an upcoming period.
Clause 87. The user device according to clause 86, the processor further configured to:
   calculate, based on the expected amount of aerosolisable material to be used and a stored indication of a user's inventory of aerosolisable material, a predicted inventory of aerosolisable material following the upcoming period; and
   take, when the predicted inventory of aerosolisable material following the upcoming period is below a threshold, a pre-emptive action.
Clause 88. The user device according to clause 87, wherein:
   the pre-emptive action comprises at least one of:
      notifying the user;
      prompting the user to order more aerosolisable material;
      ordering more aerosolisable material on behalf of the user; and
      causing the non-combustible aerosol provision system to enter an aerosolisable material conserving mode.
Clause 89. A computer-readable medium comprising instructions which, when executed by processing circuitry of a computing device, cause the computing device to:
   receive usage characteristics from a non-combustible aerosol provision system; and calculate a usage summary based at least in part on the usage characteristics.
Clause 90. The computer-readable medium according to clause 89, wherein:
   the usage characteristics relate to a single puff on the non-combustible aerosol provision system by a user.
Clause 91. The computer-readable medium according to clause 89, wherein:
   the usage characteristics relate to a plurality of puffs on the non-combustible aerosol provision system by a user.
Clause 92. The computer-readable medium according to any of clauses 89-91, wherein:
   the usage characteristics comprise at least one of:
      a puff duration of a puff on the non-combustible aerosol provision system;
      a number of puffs taken in a session of use;
      an amount of aerosolisable material consumed in using the non-combustible aerosol provision system; and
      a time at which the non-combustible aerosol provision system was used.
Clause 93. The computer-readable medium according to any of clauses 89-92, wherein:
   the usage characteristics identify when the non-combustible aerosol provision system was used; and
   calculating the usage summary comprises calculating a user's typical profile of use across a day.
Clause 94. The computer-readable medium according to clause 93, wherein:
   the usage characteristics further identify a type of pod being used with the non-combustible aerosol provision system; and
   calculating the typical profile of use comprises identifying, for one or more periods of the day, which type of pod the user typically uses during that period.
Clause 95. The computer-readable medium according to any of clause 93 to clause 94, wherein:
   the usage characteristics further identify a heater power level of the non-combustible aerosol provision system; and
      calculating the typical profile of use comprises identifying, for one or more periods of the day, which of a plurality of heater power levels supported by the non-combustible aerosol provision system, the user typically uses during that period.
Clause 96. The computer-readable medium according to any of clauses 93-95, wherein:
   the usage characteristics further identify a number of puffs taken in a session of use of the non-combustible aerosol provision system; and
   calculating the typical profile of use comprises identifying, for one or more period of the day, a typical number of puffs taken by the user in a session of use.
Clause 97. The computer-readable medium according to any of clauses 89-96 wherein:
   the usage characteristics identify a duration of one or more puffs on the non-combustible aerosol provision system taken by the user and a heater power level of the non-combustible aerosol provision system; and
   calculating the usage summary comprises determining an average duration of a puff on the non-combustible aerosol provision system for each of a plurality of heater power level supported by the non-combustible aerosol provision system.
Clause 98. The computer-readable medium according to any of clauses 89-97, wherein:
   the usage characteristics are received via Bluetooth.
Clause 99. The computer-readable medium according to any of clauses 89-98, instructions further to cause the computing device to:
   display the usage summary to the user.
Clause 100. The computer-readable medium according to any of clauses 89-99, the instructions further to cause the computing device to:
   calculate, based on the usage characteristics, an amount of aerosolisable material consumed by the non-combustible aerosol provision system during a period of use to which the usage characteristics relate.
Clause 101. The computer-readable medium according to any of clauses 89-100, the instructions further to cause the computing device to:
   calculate, based on the usage summary, an expected amount of aerosolisable material to be used during an upcoming period.
Clause 102. The computer-readable medium according to clause 101, the instructions further to cause the computing device to:
   calculate, based on the expected amount of aerosolisable material to be used and a stored indication of a user's inventory of aerosolisable material, a predicted inventory of aerosolisable material following the upcoming period; and
   take, when the predicted inventory of aerosolisable material following the upcoming period is below a threshold, a pre-emptive action.
Clause 103. The computer-readable medium according to clause 102, wherein:
   the pre-emptive action comprises at least one of:
      notifying the user;
      prompting the user to order more aerosolisable material;
      ordering more aerosolisable material on behalf of the user; and
      causing the non-combustible aerosol provision system to enter an aerosolisable material conserving mode.
Clause 104. A computer-readable medium comprising instructions which, when executed by processing circuitry of a non-combustible aerosol provision system, cause the non-combustible aerosol provision system to:
   collect usage characteristics for the non-combustible aerosol provision system; and
   communicate the usage characteristics to a user device.
Clause 105. The computer-readable medium according to clause 104, wherein the instructions further cause the non-combustible aerosol provision system to:
   detect a puff on the non-combustible aerosol provision system and to collect the usage characteristics in response to detecting the puff.
Clause 106. The computer-readable medium according to clause 104 or clause 105, wherein the instructions cause the non-combustible aerosol provision system to:
   communicate the usage characteristics to the user device via Bluetooth.

1. A method of tracking an inventory of aerosolisable material for a non-combustible aerosol provision system, the method comprising:
receiving an input indicative of a change in a user's inventory of aerosolisable material; and
updating a stored indication of the inventory of aerosolisable material based on the input indicative of the change.

2. The method according to claim 1, wherein:
the input comprises user input indicative of the change in the user's inventory of aerosolisable material.

3. The method according to claim 1, wherein:
the input comprises usage information received from the non-combustible aerosol provision system.

4. The method according to claim 3, wherein:
the usage information comprises at least one of:
a length of puff taken by the user;
a number of puffs taken by the user; and
a heater power setting of the non-combustible aerosol provision system when one or more puffs were taken.

5. The method according to claim 1 wherein:
the input is indicative that a pod of aerosolisable material for use with the non-combustible aerosol provision system has been inserted or removed.

6. The method according to claim 1, the method further comprising:
reading an initial supply level of aerosolisable material from a storage element of a pod; and
writing an updated supply level of aerosolisable material to the storage element of the pod, the updated supply level based on the input indicative of the change.

7. The method according to claim 1, wherein:
the non-combustible aerosol provision system is operable with pods containing the aerosolisable material; and
the pods are indistinguishable to the non-combustible aerosol provision system and the stored indication of the inventory represents a combined supply of aerosolisable material across one or more pods.

8. The method according to claim 1, wherein:
the non-combustible aerosol provision system is operable with pods containing the aerosolisable material;
the non-combustible aerosol provision system is able to detect two or more different types of pod and the usage information indicates a particular type of pod from which the aerosolisable material was used; and
the inventory identifies, for the different types of pod, a level of aerosolisable material for that type.

9. The method according to claim 1, wherein:
the non-combustible aerosol provision system is operable with pods containing the aerosolisable material;
the pods are separately distinguishable to the non-combustible aerosol provision system and the usage information indicates a particular pod from which the aerosolisable material was used; and
the stored indication of the inventory identifies, for each of a plurality of pods, a level of aerosolisable material in that pod.

10. The method according to claim 1, wherein:
the user input is an indication of an amount of aerosolisable material purchased by a user.

11. The method according to claim 1, the method further comprising:
detecting the purchase of aerosolisable material by a user;
determining an amount of aerosolisable material purchased; and
updating the stored indication of the inventory based on the amount of aerosolisable material purchased.

12. The method according to claim 1, the method further comprising:
detecting that the inventory of aerosolisable material is below a threshold level; and
triggering a pre-emptive action.

13. The method according to claim 12, wherein:
the pre-emptive action comprises at least one of:
notifying the user;
prompting the user to order more aerosolisable material;
ordering more aerosolisable material on behalf of the user; and
causing the non-combustible aerosol provision system to enter an aerosolisable material conserving mode.

14. The method according to claim 1, further comprising:
displaying to the user, the indication of the inventory of aerosolisable material.

15. The method according to claim 14, wherein:
displaying the indication of the inventory of aerosolisable material comprises displaying an indication of the inventory as a percentage of a full pod of aerosolisable material.

16. The method according to claim 14, wherein:
displaying the indication of the inventory of aerosolisable material comprises displaying an icon, colour or symbol corresponding to the indication of the inventory.

17. The method according to claim 1, the method further comprising:
receiving second user input indicative of an amount of aerosolisable material in a second inventory;
maintaining a second stored indication of the second inventory of aerosolisable material; and
identifying, to which of the inventory and the second inventory the user input and the usage information relate and updating the stored indication of the inventory or the second stored indication of the second inventory based on the identification.

18. The method according to claim 3, the method further comprising:
receiving from a second non-combustible aerosol provision system, second usage information indicative of an amount of aerosolisable material used; and
responsive to receiving the second usage information, updating the stored indication of the inventory of aerosolisable material.

19. A user device comprising a processor configured to:
receive an input indicative of a change in a user's inventory of aerosolisable material; and
update a stored indication of the inventory of aerosolisable material based on the input indicative of the change.

20-36. (canceled)

37. A computer-readable medium comprising instructions which, when executed by processing circuitry of a computing device, cause the computing device to:
receive an input indicative of a change in a user's inventory of aerosolisable material; and
update a stored indication of the inventory of aerosolisable material based on the input indicative of the change.

38-54. (canceled)
